(19) United States
(12) Patent Application Publication
(10) Pub. No.: US 2026/0134029 A1
(43) Pub. Date: May 14, 2026

(54) ALBUM IMAGE TAG PREVIEW METHOD

(71) Applicant: MemoriesNet Technology Limited, HONG KONG (CN)

(72) Inventor: Peijian XU, Guangzhou (CN)

(21) Appl. No.: 19/383,848

(22) Filed: Nov. 10, 2025

(30) Foreign Application Priority Data
Nov. 12, 2024 (CN) 202411604973.6

(51) Int. Cl. G06F 16/438

(52) U.S. Cl. CPC G06F 16/4393

(57) ABSTRACT

Disclosed is an album image tag preview method. The method superimposes a tag floating layer over a thumbnail window of an album, and correspondingly divides the tag floating layer, based on an image layout of the thumbnail window, into a plurality of tag regions, each of which is associated with and overlaps a respective unit image in the album; allows a user to select any unit image in the album and edit tag information for the selected unit image; and displays the tag information associated with each unit image in a floating manner within the corresponding tag region of the tag floating layer. This enables intuitive preview and quick editing of tag information, and supports search based on tag information, so that the image management becomes more convenient, accurate, and efficient.

### TECHNICAL FIELD

The present disclosure relates to the technical field of image processing and management, and particularly to an album image tag preview method, as well as a terminal operation control apparatus and a non-volatile computer-readable storage medium configured to implement the method.

### BACKGROUND

With the rapid development of digital technology, people increasingly tend to use electronic devices to store and manage a large number of image materials, including photos, pictures, and videos, the accumulated time span of which may exceed ten years. In album applications, how to efficiently and intuitively manage and search such image materials has become an important issue. In particular, when searching for a specific image taken many years ago that carries special meaning, a user often needs to browse through many pages or use different methods to locate a related image page. Traditional album management methods generally lack intuitiveness and convenience, especially when users need to annotate, classify, or search for images, resulting in complicated operations and low efficiency.

Specifically, as the frequency of capturing photos and recording videos with mobile phones increases, and as the storage capacity of mobile devices continues to expand, the number of pictures and videos stored in user albums has increased significantly, often reaching thousands or even tens of thousands. Traditional photo management methods include album categorization, in which albums with different names are created and corresponding photos are placed under them. However, this method is time-consuming and laborious. Even within a sub-album containing thousands of images, it is still difficult to quickly find a desired photo by browsing. The “Favorites” function can collect important pictures, but it essentially works the same way as album categorization, and when the number of favorite items increases, it also becomes difficult to locate a specific one quickly. Automatic recognition based on image attributes, such as detecting people or places, can identify images with clear features, but the recognition error rate remains high. For images and videos with less distinctive features, intelligent recognition often fails to locate the desired files accurately. Whether for pictures or videos, a large amount of data needs to be processed during searching and retrieval, which leads to low efficiency and high resource consumption.

### SUMMARY

To overcome the shortcomings of the prior art, an album image tag preview method is provided. Through superimposing a tag floating layer over the thumbnail window of an album, the method allows the tag information to be intuitively previewed and quickly edited and supports search based on the tag information, so that the image management becomes more convenient, accurate, and efficient.

To achieve the above objectives, an album image tag preview method is provided in the present invention, including the following steps: superimposing a tag floating layer over a thumbnail window of an album; the tag floating layer is correspondingly divided, based on the image layout of the thumbnail window, into a plurality of tag regions, each of which is associated with and overlaps a respective unit image in the album; allowing a user to select any unit image in the album and edit tag information for the selected unit image; and displaying the tag information associated with each unit image in a floating manner within the corresponding tag region of the tag floating layer.

In one embodiment, when the user needs to locate an image with a specific tag and determine the unit image associated with the corresponding tag information, the unit image associated with the tag is determined through a search based on the tag information, including: extracting all tag information and positional information of the corresponding tag region, and establishing an index database based on the extracted information; performing data matching in the index database based on input search feature information to identify matched tag information; and determining, based on the positional information of the tag region corresponding to the matched tag information, the unit image that is associated with and overlapped by the tag region.

In one embodiment, the tag information includes any one or more of numbers, text, graphics, and symbols.

In one embodiment, the user triggers editing of the tag information through a preset interactive operation in the thumbnail window of the album and/or a detailed viewing window of the unit image.

In one embodiment, the unit image is any one of image types including photographs, pictures, videos, and screenshots.

In one embodiment, when the user selects any unit image in the thumbnail window of the album to enter the detailed viewing window of a single unit image, the tag floating layer and its tag information are displayed in a layered manner, or deactivated or hidden as needed, and when the user operates to return to the thumbnail window of the album, the tag floating layer and its tag information are reactivated or displayed again.

In one embodiment, a terminal operation control apparatus is provided, including a processor; and a memory configured to store processor-executable instructions. The processor is configured to implement one of the above-described methods.

In one embodiment, a non-volatile computer-readable storage medium storing computer program instructions is provided. When the computer program instructions are executed by the processor, the instructions cause the processor to implement one of the above-described methods.

The present invention, adopting the above-mentioned solution, has the following beneficial effects: The invention provides an album image tag preview method that utilizes a tag floating layer to enable quick editing of tag information, so that users can operate freely according to their preferences and intuitive preview is achieved. In addition, the method supports search based on tag information, making image management more convenient and efficient. Furthermore, the method offers excellent user interactivity and broad applicability, meeting diverse user requirements for image management.

### BRIEF DESCRIPTION OF THE DRAWINGS

FIG. 1 is a flow diagram of an album image tag preview method;

FIG. 2 is a schematic diagram showing the separated form of the thumbnail window and tag floating layer;

FIG. 3 is a schematic diagram showing the layered structure of the thumbnail window and tag floating layer of the album;

FIG. 4 is a flow diagram of the searching and matching process; and

FIGS. 5-7 illustrate specific embodiments of the album image tag preview method.

### DETAILED DESCRIPTION

To facilitate understanding of the present disclosure, a more comprehensive description of the present disclosure is provided below with reference to the accompanying drawings, in which preferred embodiments of the present disclosure are shown. However, it should be understood that the disclosure may be embodied in many different forms and should not be construed as limited to the embodiments set forth herein. The embodiments are provided so that the disclosure of the present invention may be thoroughly and fully understood.

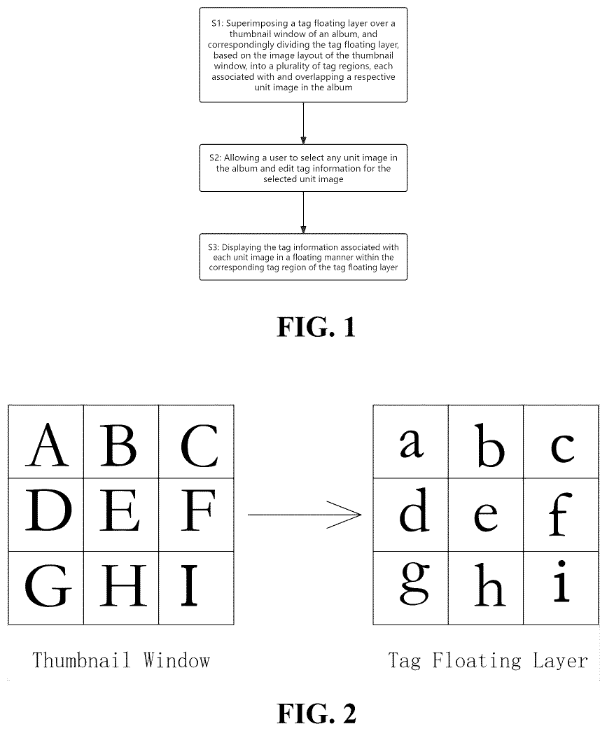

Referring to FIGS. 1-4, in one embodiment, an album image tag preview method is provided. The method allows a user to freely edit customized tag information for unit images stored in an album, and to display the edited tag information in a floating manner within the corresponding tag region of a tag floating layer. In this manner, the user can intuitively and clearly identify a corresponding unit image according to the tag information, and quickly recognize and locate desired images or videos from a large number of pictures in the album. The edited tag information does not alter the original graphical properties of the unit images.

Specifically, the embodiment includes the following steps:

Step S1: Superimposing a tag floating layer over a thumbnail window of an album, and correspondingly dividing the tag floating layer, based on the image layout of the thumbnail window, into a plurality of tag regions, each of which is associated with and overlaps a respective unit image in the album.

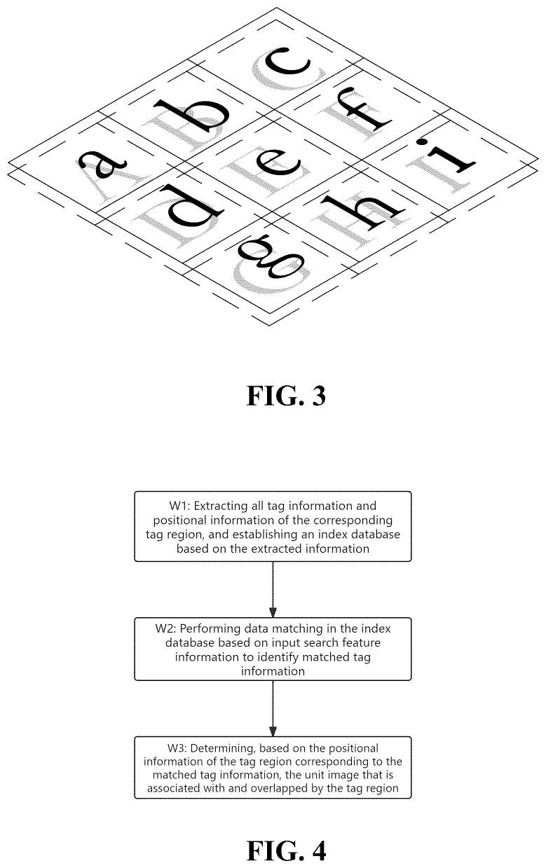

Specifically, for example, as shown in FIG. 2, the thumbnail window of the album displays nine unit images arranged in a grid layout. The thumbnail window serves as a bottom layer, and each unit image has a unique file name that may serve as an index for subsequent search and matching. For ease of explanation, the file names of the nine unit images shown in FIG. 2 are defined as A, B, C, D, E, F, G, and I. Taking FIG. 3 as an example, the tag floating layer likewise includes nine tag regions arranged in a grid layout, each of which corresponds to and associates with one of the nine unit images in the thumbnail window. For ease of explanation, the nine tag regions are defined as a, b, c, d, e, f, g, and i. Accordingly, each tag region is respectively associated with a corresponding unit image, for example: “a→A”, “b→B”, . . . “i→I”. The tag floating layer serves as a top layer and is superimposed above the thumbnail window of the album. The tag floating layer is presented in a transparent manner to allow the user to view the underlying unit images through the tag floating layer without changing the user's existing habits. By adopting the superimposing structure of the tag floating layer and the thumbnail window, the actual operation process remains consistent with that of an existing album interface, so that additional operation habits are not required.

Step S2: Allowing a user to select any unit image in the album and edit tag information for the selected unit image.

Specifically, the user may select any unit image in the album and edit tag information by entering a preset tag or a customized tag. For example, the user may select the unit image having the file name “C” and edit the customized tag information “Contract” as the tag information; or select the unit image having the file name “D” and edit and select the preset tag “Scenery” as the tag information; or select the unit image having the file name “E” and edit and select the combined tag information “A Photo” and “Yellow Crane Tower” as the tag information. The tag information may take various forms, including numbers, text, graphics, or symbols. In actual use, the user may freely choose appropriate content as the tag information according to personal needs, which is not limited herein.

Step S3: Displaying the tag information associated with each unit image in a floating manner within the corresponding tag region of the tag floating layer.

Specifically, after the user completes editing tag information for any unit image, the tag floating layer displays the tag information within the tag region corresponding to that unit image. This allows the user, when previewing the album in the thumbnail window, to directly view the tag information floating above the unit image, so that the user can intuitively and quickly locate the desired unit image. For example, as shown in FIG. 4, the thumbnail window of the album and the superimposing tag floating layer display tag information “Contract” in tag region c, or “Scenery” in tag region d. Accordingly, when the user needs to find a unit image related to contracts, the user can directly locate the corresponding unit image by identifying the tag “Contract” in the thumbnail window.

In one embodiment, when the user selects any unit image in the thumbnail window of the album to enter a detailed viewing window of a single unit image, the tag floating layer and its tag information can be displayed in a layered manner, deactivated, or hidden as needed. When the user operates to return to the thumbnail window of the album, the tag floating layer and the tag information are reactivated or displayed again to restore the previous preview state. In this way, interference of the tag information with the user's visual perception during the detailed viewing of a single unit image can be avoided, so that the user's browsing experience is not affected. Furthermore, the tag floating layer and its tag information may be immediately deactivated or hidden. Alternatively, the tag floating layer and its tag information may also be deactivated or hidden after a preset delay, which allows the user to briefly view the tag information before continuing to browse the unit image. The specific manner of deactivating or hiding is not particularly limited herein, and one of ordinary skill in the art may select an appropriate manner as needed.

In one embodiment, the user can flexibly perform secondary editing, deletion, or addition of tags for existing tag information, and the tag floating layer updates the tag information in real time.

In one embodiment, the user may trigger the editing of tag information through a preset interactive operation in the thumbnail window and/or in the detailed viewing window of a unit image. For example, in the thumbnail window of the album, the user may perform a preset “two-finger long-press” operation to select a unit image for which tag information is to be added or modified. In response to the user's selection, the system pops up or switches to a tag-editing interface to allow the user to input or modify tag information associated with the selected unit image. The interactive operation is not limited to the above-described “two-finger long-press” and may be implemented in other derivative manners.

In one embodiment, when the user inputs search feature information, unit images associated with the tag are determined through a search based on the tag information, including the following steps:

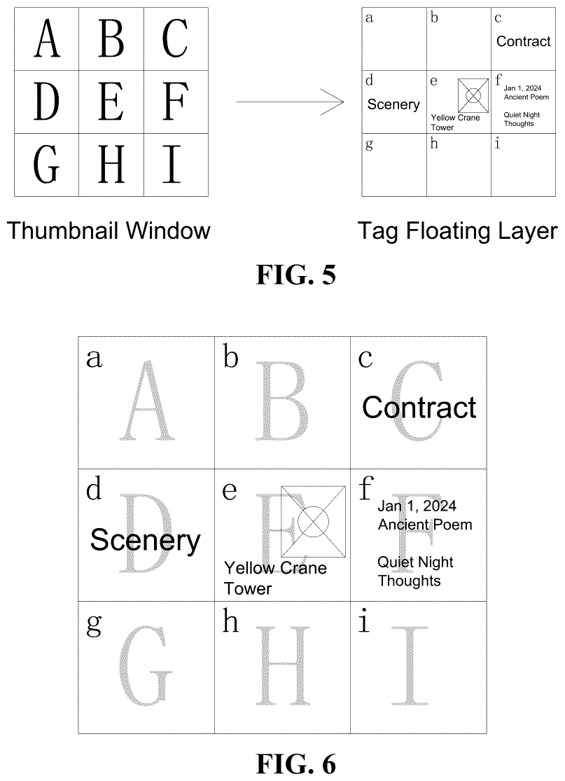

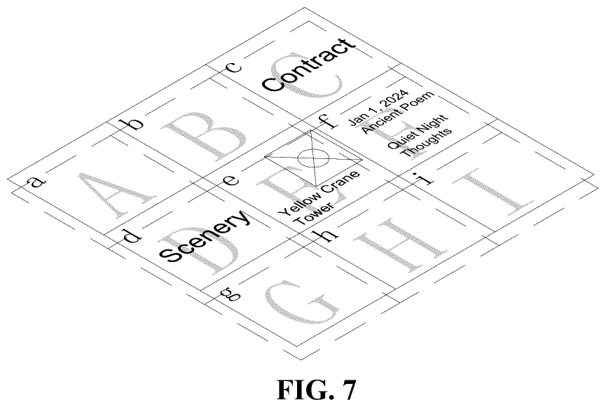

Step W1: Extracting all tag information and the positional information of the corresponding tag region, and establish an index database based on the extracted information. [1] Specifically, the system extracts all tag information and the positional information of the corresponding tag regions, establishes and maintains an index database. The database is used to store the association relationships between the tag information and the unit images. For ease of understanding, referring to FIGS. 5-7, the following schematic index database is formed as shown in Table 1.

TABLE 1

| Unit | Tag | | | |
|---|---|---|---|---|
| Image | Region | Tag 1 | Tag 2 | Tag 3 |
| A | a | | | |
| B | b | | | |
| C | c | Contract | | |
| D | d | Scenery | | |
| E | e | A graphic | Yellow Crane Tower | |
| F | f | Jan. 1, 2024 | Ancient Poem | Quiet Night |
| | | | | Thoughts |
| G | g | | | |
| I | i | | | |

Step W2: Performing data matching in the index database based on input search feature information to identify matched tag information.

Specifically, when the user needs to locate an image with a specific tag, the user may input search feature information (such as a keyword or an image) into a search box. The system performs a matching search in the index database to find the tag information that meets the search condition. For example, when the user inputs the keyword “Yellow Crane Tower,” the system performs a matching search in the index database and identifies the matching “Yellow Crane Tower” tag information.

Step W3: Determining, based on the positional information of the tag region corresponding to the matched tag information, the unit image that is associated with and overlapped by the corresponding tag region.

Specifically, based on the matched tag information, the system determines the unit image associated therewith and directly locates the position of the image in the album. If multiple images have the same tag, an operation such as a “Next” button may be provided to allow the user to navigate to the next corresponding image. Alternatively, the images having the same tag may be arranged in a search result list. For example, based on the matched “Yellow Crane Tower” tag information, the system determines the associated tag region e and its corresponding unit image E, which may then be displayed as highlighted prompts within the thumbnail window or extracted and arranged in a search result list. The specific implementation may be selected as needed and is not particularly limited herein.

In one embodiment, the unit image may be any one of various image types, including photographs, pictures, videos, and screenshots.

Accordingly, through the above-described search and matching based on tag information, convenient and accurate searching and positioning can be achieved. Specifically, when the user needs to locate an image with a particular tag, a matching search is performed between the search feature information to be retrieved and the tag information. Compared with performing search and retrieval directly on the original image and video data having a large amount of information, the efficiency of locating a target image in the album is improved. In addition, since the search range of the search feature information is limited to the tag information rather than the original image data containing massive amounts of information, the amount of data processing and the resources consumed for search and retrieval are greatly reduced.

In one embodiment, a terminal operation control apparatus is provided. The apparatus specifically includes a processor, a memory, a display module and an input module. The processor is configured to execute instructions stored in the memory to implement the respective steps of the album image tag preview method above. The memory is configured to store processor-executable instructions, tag information, unit image data, and other necessary data. The memory may be any form of storage device such as a RAM, a ROM, a flash memory, or a hard disk drive. The display module is configured to display user interface elements such as the thumbnail window, tag floating layer, and search results. And the input module is configured to receive user input operations, such as clicking, long pressing, or swiping, to trigger functions such as tag information editing and searching.

When the user selects a unit image through the input module and triggers the tag editing function, the processor reads the relevant instructions and data stored in the memory and performs operations to edit and display the tag information.

When the user inputs search feature information to perform a search, the processor searches and matches tag information satisfying the conditions in the memory, and then updates the user interface on the display module to present the search results.

The processor is further configured to control the display and hiding of the tag floating layer according to user operations, such as entering a detailed viewing mode or returning to the thumbnail window.

In one embodiment, a non-volatile computer-readable storage medium is further provided. The storage medium stores computer program instructions to implement the above-described album image tag preview method. When the computer program instructions are executed by the processor, the instructions cause the processor to perform tasks including tag information editing, display, searching, and user interaction. The non-volatile computer-readable storage medium may be any form of storage device, such as a USB flash drive, an SD card, a solid-state drive, or an optical disc.

The embodiments described above are merely preferred embodiments of the present invention and are not intended to limit the scope of the invention in any form. Any person of ordinary skill in the art may, without departing from the scope of the technical solution of the present invention, make various modifications, improvements, or adjustments to the provided technical content, all of which shall be regarded as equivalent embodiments of the invention. Therefore, all equivalent or corresponding modifications made based on the technical concept of the present invention shall fall within the scope of the invention.

It must be noted that as used herein and in the appended claims, the singular forms “a”, “an”, and “the” include their plural equivalents, unless the context clearly dictates otherwise.

1. An album image tag preview method, comprising:
superimposing a tag floating layer over a thumbnail window of an album, wherein the tag floating layer is correspondingly divided, based on an image layout of the thumbnail window, into a plurality of tag regions, each of which is associated with and overlaps a respective unit image in the album;
allowing a user to select any unit image in the album and edit tag information for the selected unit image; and
displaying the tag information associated with each unit image in a floating manner within the corresponding tag region of the tag floating layer.

2. The album image tag preview method according to claim 1, when the user needs to locate an image with a specific tag, the unit image associated with the tag is determined through a search based on the tag information, comprising:
extracting all tag information and positional information of the corresponding tag region, and establishing an index database based on the extracted information;
performing data matching in the index database based on input search feature information to identify matched tag information; and
determining, based on the positional information of the tag region corresponding to the matched tag information, the unit image that is associated with and overlapped by the tag region.

3. The album image tag preview method according to claim 1, wherein the tag information comprises any one or more of numbers, text, graphics, and symbols.

4. The album image tag preview method according to claim 1, wherein the user triggers editing of the tag information through a preset interactive operation in the thumbnail window of the album and/or a detailed viewing window of the unit image.

5. The album image tag preview method according to claim 1, wherein the unit image is any one of image types including photographs, pictures, videos, and screenshots.

6. The album image tag preview method according to claim 1, wherein when the user selects any unit image in the thumbnail window of the album to enter the detailed viewing window of a single unit image, the tag floating layer and its tag information are displayed in a layered manner, deactivated, or hidden as needed, and when the user operates to return to the thumbnail window of the album, the tag floating layer and its tag information are reactivated or displayed again.
